(19) United States
(12) Patent Application Publication
(10) Pub. No.: US 2007/0027780 A1
(43) Pub. Date: Feb. 1, 2007

(54) Systems and methods for providing a product description

(76) Inventor: Gregory P. Hopkins, Milton (CA)

Correspondence Address: MCGARRY BAIR PC, 171 MONROE AVENUE, N.W., SUITE 600, GRAND RAPIDS, MI, 49503, US

(21) Appl. No.: 11/491,374

(22) Filed: Jul. 24, 2006

Related U.S. Application Data
(60) Provisional application No. 60/701,998, filed on Jul. 25, 2005.
(60) Provisional application No. 60/701,997, filed on Jul. 25, 2005.

(51) Int. Cl. G06Q 30/00

(52) U.S. Cl. 705/26

(57) ABSTRACT

A system for providing a product description, for example at a point of sale, has a database storing a product description, a code related to the product description within the database, a communication device for receiving the code and transmitting the product description and a display for informing potential customers of the code. A method of providing a product description has steps of displaying a code, receiving a communication including the code, retrieving a product description from a database in response to receiving the communication and transmitting the product description.

This is an application claiming the benefit under 35 USC 119(e) of U.S. application Ser. No. 60/701,998 filed Jul. 25, 2005 and 60/701,997 filed Jul. 25, 2005. Application Ser. Nos. 60/701,998 and 60/701,997 are incorporated herein, in their entirety, by this reference to them for the benefit of their disclosure, although the invention described in this document is not limited by any statements in the incorporated documents.

### FIELD

This specification relates to marketing of products, and, in particular to systems and methods for marketing products.

### BACKGROUND

The comments in this background section are not an admission that anything discussed in this section is prior art or part of the common general knowledge of persons skilled in the art in any country.

Everyday consumers purchase products based on their knowledge and perceptions of the products in relation to their perceived needs and desires. As an example, consumer products include, without limitation, items such as vehicles, home-appliances, home-electronics, power-tools, prepared foods, clothes, music, toys, books etc. The marketing of consumer products occurs on a number of levels, including without limitation, brand management, product placement, competitive pricing, sales-force training, consumer reports and the like. The marketing also occurs in a number of environments.

In particular, a point-of-sale or display is an interesting marketing environment in that such an environment presents a manufacturer with a number of challenges. Generally, at a point-of-sale or display, a manufacturer sometimes experiences difficulty in ensuring that potential consumers have the information about product offerings of the manufacturer that the manufacturer wants the potential consumers to have when deciding to make a purchase. Such information may sway potential consumers at a point-of-sale in ways that either benefit or cost the manufacturer a sale.

One option for a manufacturer is to open retail outlets staffed by employees that are trained to be knowledgeable of the product offerings of the manufacturer and actively dissuade potential consumers from buying products provided by another competing manufacturer. This option allows the manufacturer an opportunity to better manage consumer perceptions of the product offerings and may be effective in larger cities and suburbs. However, in smaller locations the demand for a certain category of consumer product may not be high enough to warrant the opening of such a retail location. Moreover, the overhead cost of operating such retail locations may be too much for some manufacturers to bear in order to bring their products to the consumer market.

Another option is to engage third-party resellers, such a department store or a store specializing in one or more categories of consumer products (e.g. home-electronics and home-appliances). Manufacturers that have such arrangements have effectively outsourced their direct sales efforts to another company (i.e. the third-party reseller) and a point-of-sale environment provided by a third-party reseller presents a number of potential pitfalls to individual manufacturers. A first potential pitfall is that a particular manufacturer cannot guarantee that the employees of a third-party reseller are sufficiently knowledgeable about specific product offering, and thus able to adequately describe the features and advantages provided by the product offering to potential consumers. A second potential pitfall is that a first manufacturer may not be aware of incentives provided by a second manufacturer to the third-party reseller that cause the employees of the third-party reseller to more aggressively push the products of the second manufacturer, and possible dissuade potential consumers from the product offerings of the first manufacturer. A third potential pitfall is that the first manufacturer may not be aware of incentives provided by the second manufacturer to potential consumers through the third-party reseller that make the products of the second manufacturer more desirable at the point-of-sale. The two latter scenarios present another hidden pitfall, in that goodwill towards the first manufacturer from consumers may be lost in the market if the third-party reseller is somehow more closely aligned with the second manufacturer.

### SUMMARY

The following summary is intended to introduce the reader to the disclosure but not to define any invention. One or more inventions may reside in any combination of apparatus elements or process steps found anywhere in this document. An object of an invention is to provide a system or method to help in marketing a product, for example by providing a product description to a potential customer.

According to an aspect of an invention there is provided a system for providing product descriptions comprising: a database storing a product description; a code related to the product description within the database; a display to advise a user of the code; and a communication means connected to the database for receiving the code and transmitting the product description. In use a user transmits the displayed code to the communication means to access the product description stored on the database.

In some embodiments, there are multiple codes related to multiple product descriptions within the database. The codes and product descriptions may be uniquely paired. In some embodiments, the code is related to the product descriptions through a menu. Some codes and product descriptions may be uniquely paired, while some product descriptions are related to multiple codes.

In some embodiments, the product description includes at least one of text, pre-recorded audio messages, still-pictures, video, video coupled with audio, each in an electronic format, and/or any combination thereof.

In some embodiments, the communications means includes at least one of elements of and/or connections to a public and/or private communication network such a cellular network, a wireless Local Area Network (LAN), the Internet, an intranet, a virtual private network, portions of a Publicly Switched Telephone Network (PSTN), Ethernet connections, Universal Serial Bus Connections (USB), and the like.

In some embodiments, the display includes at least one of a a visual display or an audio message.

According to an aspect of an embodiment of an invention there is provided a method of providing a product description: displaying a code for a product; receiving a communication conveying the code; retrieving a product description from a database in response to receiving the communication; and, transmitting the product description.

Other aspects and features of one or more inventions will become apparent, to those ordinarily skilled in the art, upon review of the following description of one or more embodiments of one or more inventions.

### BRIEF DESCRIPTION OF THE DRAWINGS

For a better understanding of one or more inventions, and to show more clearly how they may be carried into effect, reference will now be made, by way of example, to the accompanying drawings, which illustrate aspects of embodiments of one or more inventions and in which:

FIG. 1 is an illustration of a system for providing product descriptions to consumers according to an embodiment of an invention;

FIG. 2 is a flow chart depicting a method for providing product descriptions to consumers according to an aspect of an invention.

### DETAILED DESCRIPTION

Various apparatuses or processes will be described below to provide an example of an embodiment of each claimed invention. No embodiment described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention. The applicants, inventors and owners reserve all rights in any invention disclosed in an apparatus or process described below that is not claimed in this document and do not abandon, disclaim or dedicate to the public any such invention by its disclosure in this document.

An embodiment of an invention provides a system and method for providing product descriptions directly to potential consumers at a point-of-sale or display. A point-of-sale or display is any location in which product are made available for inspection by potential consumers, such as for example, and without limitation, a manufacturer-specific retail location, a third-party reseller retail location or a tradeshow.

Generally, in accordance with some aspects of an invention, a system includes a database for storing product descriptions that can be reviewed on a personal communication device. The product descriptions are related to codes within the database. The system also includes at least one type of communication means for receiving the codes and sending product descriptions to a personal communication device. A display presents the code to potential consumers in any of a number of environments, including, but not limited to a retail store. In some embodiments, within the database, a respective code is paired with a particular product offering of a manufacturer so that the system can poll the database for a particular product description based on the code. That is, each product description, or discrete set of product descriptions, in the database may be assigned a unique code. Alternately, each code may relate to a menu of product descriptions. The product descriptions under one menu may be unique to the product associated with the code or some or all of the product descriptions may be listed under multiple menus associated with different codes.

In some embodiments, a product description includes, without limitation, at least one of text, pre-recorded audio messages, still-pictures, video, video coupled with audio, each in an electronic format, and/or any combination thereof. In some embodiments the code may be a discrete set of characters, such as number or letters, or the code may be a part of a larger set of characters such as, without limitation, a telephone/fax number (e.g. a toll-free telephone/fax number).

In some embodiments, the communication means includes, without limitation, elements of and/or connections to a public and/or private communication network such a cellular network, a wireless Local Area Network (LAN), the Internet, an intranet, a virtual private network, portions of a Publicly Switched Telephone Network (PSTN), Ethernet connections, Universal Serial Bus Connections (USB), and the like. That is, communication means is any electronic mechanism/system that can be employed to transmit product description information from or to a personal communication device.

In some embodiments, the display includes visual or audio information such as, without limitation, a billboard, an audio message, a poster, a sticker and/or tag placed on or near displayed product offerings or an advertisement made apart form the physical product display.

In general, a system according to aspects of an embodiment of an invention includes any suitable combination of devices and connections to other networks and/or systems in addition to any suitable combination of hardware, software and firmware for supporting desired functionality and modes of operation.

In operation a potential consumer, perhaps while browsing at a retail location or show, uses a personal communication device (e.g. a cellular-phone, a personal digital assistant or laptop computer) to request via the code and communication means a particular product description from the database. In response, the database is accessed and a product description is sent to the personal communication device. The potential consumer can then use the feature set provided on the personal communication device to review the product description. In some embodiments the user may interact with the database, for example by selecting product descriptions form a menu.

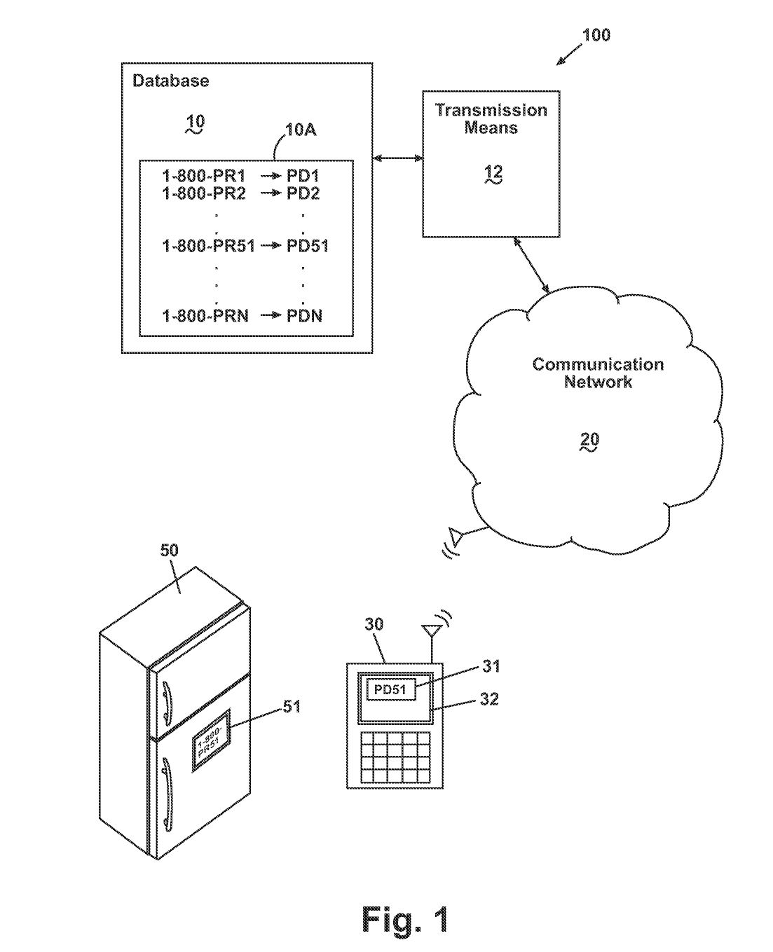

Referring to FIG. 1, shown is a system 100 in accordance with an embodiment of an invention. The system 100 includes a database 10, a communications means 12, and a display 51. The database 10 includes a portion of a computer readable medium 10a storing thereon a list of codes, (e.g. XPR2) and a list of corresponding product descriptions (e.g. PD2) and, optionally, product description menus (e.g. PDM1). That is, a code may be paired with a corresponding product description within the database 10 or with a product description menu that is associated with one or more product descriptions. Some product descriptions may be associated with multiple menus or codes or with a combination of menus and codes. The communication means 12 is connectable to a communication network 20, which as described above includes a suitable combination of hardware, software and firmware and/or connections to various types of elements of a communication network. The communication network 20 works with the system 100 but is not part of the system 100.

The display 51 is a printed notice located on a refrigerator 50 (or another product), which may in turn be located at a retail outlet or show. A potential at the customer or show brings with them a personal communication device 30 (e.g. a cell phone) which may interact with, but is not part of system 100.

In operation, while the potential consumer is looking at samples of products, the potential customer may come across the refrigerator 50. At this point the potential consumer is able to contact the database 10 through communication means 12, for example by calling a telephone number. The telephone number may be a toll free telephone number and may be provided on the display 51 or provided to the customer on another display or through other advertising. The call is placed over the communication network 20 to which the potential consumer subscribes. The call is received from the communication network 20 by the communication means 12. Once connected to the database 10, user continues to poll the database 10 by entering the code and, optionally, a further signal representing a menu selection.

For example, a potential consumer can enter code XPR51 and will then be prompted to select features from product description menu PDM51 to view in more detail. For example, on the cellular phone 30, the potential consumer could press: “1” to receive product description PD51a containing more information about the construction of the refrigerator 50; “2” to receive more information about the control functions of the refrigerator 50; “3” to receive more information about the internal features of the refrigerator 50; and/or “4” to receive more information about the external features of the refrigerator 50.

To provide information, the system 100 retrieves the requested product description from the database 10 and transmits the product description back to the cellular phone 30. At the cellular phone, the product description is displayed on the monitor 32 or broadcast through the speaker. Any and all such information could be provided in a variety and combination of formats (i.e. text, audio, video, etc) and languages. Additionally and/or alternatively, a web-enabled version of the menu system described with respect to the system 100a could also be provided for web-enabled personal communication devices.

Additionally and/or alternatively, the database 10 and communications means 12 may be managed by a controller (not shown), such as a server or computer that monitors received calls, polls the database 10 and returns the appropriate product descriptions to the transmission means 12 for subsequent transmission. The controller may also operate a menu function as described above, for example by converting the code and a menu selection to a second code which is sent to the database to retrieve a desired part of a product message. Additionally and/or alternatively, respective email addresses may also be provided in the database 10, linked to the product descriptions, and provided on displays (e.g. display 51).

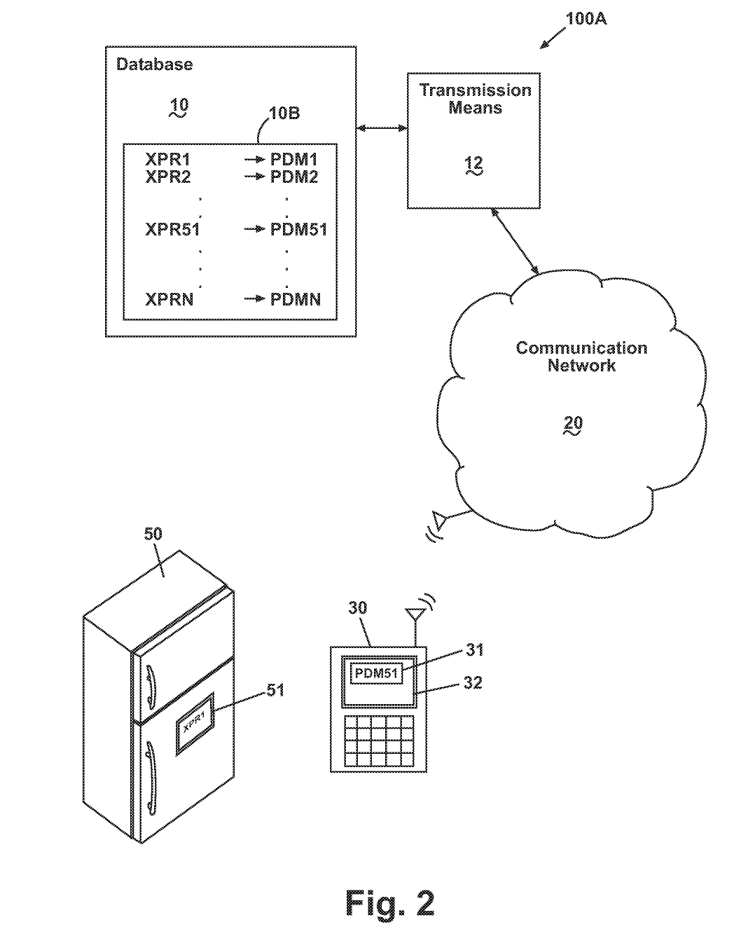

Referring to FIG. 2, shown is a flow chart depicting a method for providing product descriptions to consumers according to an aspect of an invention. Starting at step 2-1, the method includes providing a unique code for a product to potential consumers. The step of providing the unique code may be, without limitation, accomplished by the display of the code on a sticker, price tag, billboard, poster, website, television etc. or radio or audio broadcast.

At step 2-2, the method includes receiving a communication including the code. Examples of a communication include a telephone call, an email, a text message, etc. Additionally and/or alternatively, the communication may be made using a combination of a general telephone number and a unique product identification code entered by the potential consumer after the general telephone number is employed.

At step 2-3, a database storing product descriptions is polled to retrieve a corresponding product description. Subsequently, at step 2-4, the retrieved product description is sent to a personal communication device for the potential consumer to review.

While the above description provides example embodiments, it will be appreciated that the disclosed invention or inventions are susceptible to modification and change without departing from the fair meaning and scope of claims relating to them. Accordingly, what has been described is merely illustrative of the application of aspects of embodiments of one or more inventions. Numerous modifications and variations of the one or more inventions are possible in light of the above teachings. It is therefore to be understood that inventions may be practiced otherwise than as specifically described herein and still be within the scope of one or more of the appended claims.

I claim:

1. A system for providing product descriptions comprising:
a database storing a product description;
a code related to the product description within the database;
a communications means for receiving the code and transmitting the product description; and,
a display for informing potential customers of the code.

2. A method of providing a product description comprising:
displaying a code;
receiving a communication including the code;
retrieving a product description from a database in response to receiving the communication; and
transmitting the product description.
